(19) United States
(12) Patent Application Publication
(10) Pub. No.: US 2025/0149887 A1
(43) Pub. Date: May 8, 2025

(54) RISK MITIGATION SYSTEM FOR ELECTRICAL POWER GRIDS

(71) Applicant: NEC Laboratories America, Inc., Princeton, NJ (US)

(72) Inventors: Yangmin Ding, East Brunswick, NJ (US); Ting Wang, West Windsor, NJ (US)

(21) Appl. No.: 18/937,680

(22) Filed: Nov. 5, 2024

Related U.S. Application Data
(60) Provisional application No. 63/596,706, filed on Nov. 7, 2023.
(60) Provisional application No. 63/621,791, filed on Jan. 17, 2024.

(51) Int. Cl. H02J 3/00; G06F 18/25; G06N 3/08

(52) U.S. Cl. CPC H02J 3/0012; G06F 18/251; G06N 3/08

(57) ABSTRACT

Systems and methods for a risk mitigation system for electrical power grids. To mitigate risks such as natural destructive forces, collected risk data and EPG data can be fused to obtain fused data. The vulnerability metric and fragility metric of the EPG based on risk profiles generated from the fused data can be predicted with a physics-informed neural network (PINN) trained with the fused data. EPG threat metrics can be developed by integrating the vulnerability metric, fragility metric, and the risk profiles into an integrated score that determines the probability of failure of the EPG caused by natural destructive forces. The present embodiments can perform a corrective action with an automated helper to mitigate the risks to the EPG caused by the natural destructive forces determined from the EPG threat metrics.

### RELATED APPLICATION INFORMATION

This application claims priority to U.S. Provisional App. No. 63/596,706, filed on Nov. 7, 2023, and to U.S. Provisional App. No. 63/621,791, filed on Jan. 17, 2024, incorporated herein by reference in their entirety.

### BACKGROUND

### Technical Field

The present invention relates to risk mitigation systems for utility infrastructure and more particularly to risk mitigation system for electrical power grids.

### Description of the Related Art

Electrical power grids (EPGs) are an essential utility infrastructure to the modern world. They generate, distribute and maintain the electricity to power cities, homes, and the public space. However, EPGs are vulnerable to naturally-occurring destructive forces such as wildfires, flooding, landslides, etc. Such destructive forces can cause power outages and restoring power back to locations affected by the power outages is directly linked to the preparedness of the EPGs handling their power needs.

### SUMMARY

According to an aspect of the present invention, a computer-implemented method is provided for mitigating risks for electrical power grids, including fusing collected risk data and electrical power grid (EPG) data to obtain fused data, predicting vulnerability metric and fragility metric of the EPG based on risk profiles generated from the fused data with a physics-informed neural network (PINN) trained with the fused data, developing EPG threat metrics by integrating the vulnerability metric, fragility metric, and the risk profiles, and performing a corrective action to mitigate risks to the electrical power grids determined from the EPG threat metrics.

According to another aspect of the present invention, a risk mitigation system for electrical power grids is provided including a memory device, one or more processor devices operatively coupled with the memory device to fuse collected risk data and electrical power grid (EPG) data to obtain fused data, predict vulnerability metric and fragility metric of the EPG based on risk profiles generated from the fused data with a physics-informed neural network (PINN) trained with the fused data, develop EPG threat metrics by integrating the vulnerability metric, fragility metric, and the risk profiles, and perform a corrective action to mitigate risks to the electrical power grids determined from the EPG threat metrics.

According to yet another aspect of the present invention, a non-transitory computer program product is provided including a computer-readable storage medium having program code for mitigating risks for electrical power grids, wherein the program code when executed on a computer causes the computer to fuse collected risk data and electrical power grid (EPG) data to obtain fused data, predict vulnerability metric and fragility metric of the EPG based on risk profiles generated from the fused data with a physics-informed neural network (PINN) trained with the fused data, develop EPG threat metrics by integrating the vulnerability metric, fragility metric, and the risk profiles, and perform a corrective action to mitigate risks to the electrical power grids determined from the EPG threat metrics.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for mitigating risks for electrical power grids, in accordance with an embodiment of the present invention;

FIG. 2 is a block diagram illustrating a system architecture for a physics-informed neural network, in accordance with an embodiment of the present invention;

FIG. 3 is a block diagram illustrating a system implementing a practical application of a risk mitigation system for electrical power grids, in accordance with an embodiment of the present invention;

FIG. 4 is a block diagram illustrating a computing device implementing a risk mitigation system for electrical power grids, in accordance with an embodiment of the present invention; and

FIG. 5 is a block diagram illustrating a system that implements software and hardware components of a risk mitigation system for electrical power grids, in accordance with an embodiment of the present invention.

### DETAILED DESCRIPTION OF PREFERRED EMBODIMENTS

In accordance with embodiments of the present invention, systems and methods are provided for a risk mitigation system for electrical power grids.

The present embodiments can mitigate risks for electrical power grids (EPG). To mitigate risks such as natural destructive forces, collected risk data and EPG data can be fused to obtain fused data. The vulnerability metric and fragility metric of the EPG based on risk profiles generated from the fused data can be predicted with a physics-informed neural network (PINN) trained with the fused data. EPG threat metrics can be developed by integrating the vulnerability metric, fragility metric, and the risk profiles into an integrated score that determines the probability of failure of the EPG caused by natural destructive forces. The present embodiments can perform a corrective action with an automated helper to mitigate the risks to the EPG caused by the natural destructive forces determined from the EPG threat metrics.

The modern electrical power grid can face complex challenges from natural destructive forces, particularly wildfires. Traditional methodologies employed in assessing the vulnerability and fragility of power grids often adopt a generalized approach. They frequently evaluate the potential occurrence of natural destructive forces and their corresponding impacts on the grid without delving into the distinct causes of these natural destructive forces. This oversight can lead to a superficial understanding, potentially resulting in misallocated resources, inefficient mitigation measures, and heightened grid susceptibility.

The primary issue lies in the absence of a nuanced differentiation between the various causes of natural destructive forces, such as wildfires. Factors such as human activities, natural triggers, equipment malfunctions, and others, each present unique patterns, intensities, and implications for the power grid. For instance, a wildfire ignited due to an equipment malfunction near power lines can manifest differently in terms of duration, size, and proximity to grid components compared to one caused by natural destructive forces such as lightning. Consequently, grid vulnerability and fragility analyses that do not account for these specific causes can oversimplify the threat landscape, potentially leading to suboptimal protective measures.

Moreover, traditional approaches often lack the depth provided by advanced analytical tools like explainable AI, which can offer detailed insights into the potential causes of natural destructive forces based on multifarious factors. Without leveraging such advanced methodologies, power grid operators and stakeholders may remain inadequately informed, rendering the grid exposed to preventable risks.

The present embodiments can address this gap by proposing a novel methodology that integrates the predictions of risks and its consequences, such as natural destructive force causes, derived from an explainable AI model, into grid vulnerability and fragility analyses. By doing so, the present embodiments can provide a more comprehensive, accurate, and actionable assessment of the risks natural destructive forces pose to the power grid. Thus, the present embodiments can ensure not only enhanced grid resilience but also more informed, targeted, and effective mitigation strategies.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

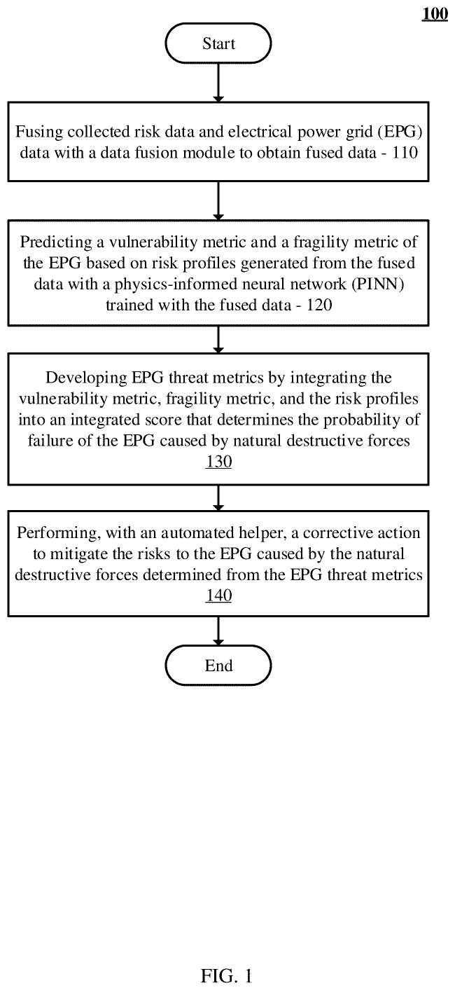

Referring now in detail to the figures in which like numerals represent the same or similar elements and initially to FIG. 1, a high-level overview of a computer-implemented method for mitigating risks for electrical power grids is illustratively depicted in accordance with one embodiment of the present invention.

The present embodiments can mitigate risks for electrical power grids (EPG). To mitigate risks such as natural destructive forces, collected risk data and EPG data can be fused to obtain fused data. The vulnerability metric and fragility metric of the EPG based on risk profiles generated from the fused data can be predicted with a physics-informed neural network (PINN) trained with the fused data. EPG threat metrics can be developed by integrating the vulnerability metric, fragility metric, and the risk profiles into an integrated score that determines the probability of failure of the EPG caused by natural destructive forces. The present embodiments can perform a corrective action with an automated helper to mitigate the risks to the EPG caused by the natural destructive forces determined from the EPG threat metrics.

Referring now to block 110 of FIG. 1, showing an embodiment of a method of fusing collected risk data and electrical power grid (EPG) data to obtain fused data.

The present embodiments can leverage both the depth of historical data and the immediacy of real-time inputs. Historical data can provide patterns and trends, while real-time data can offer current context. This combined data approach allows for a richer prediction space. For example, if a particular region has a history of arson-related fires and the artificial intelligence (AI) model identifies arson as a likely cause for a new fire, the threat metric can be adjusted accordingly.

Risk data from natural destructive forces can be collected from remote sensing datasets which include elevation, wind direction and speed, minimum and maximum temperatures, humidity, precipitation, drought index, normalized difference vegetation index (NDVI), energy release component (ERC), and population density for the target region and time duration. The data can be obtained from satellite-based remote sensing platforms like the MODIS (Moderate Resolution Imaging Spectroradiometer) and Landsat series. Additionally, local meteorological stations can provide data for wind speed, temperature, humidity, etc. Drones equipped with infrared sensors can also be employed for high-resolution, real-time data, especially in challenging terrains.

Collected risk data can include historical natural destructive force records, environmental factors and cause-specific details. The historical natural destructive force records can include data on past natural destructive forces, such as their locations, durations, intensities, spread patterns, and causes. The environmental factors can include information about the weather conditions, vegetation types, and terrain features where natural destructive forces, such as wildfires, have occurred. These factors can influence how wildfires start and spread. The cause-specific details can include specific data that characterizes these events, such as ignition sources, human activities involved, or natural conditions.

The causes of wildfires can include debris and open burning, natural occurrences (e.g., lightning strikes, etc.), arson, equipment and vehicle use, recreation and ceremony (e.g., campfire, etc.), fire misuse, smoking, power generation/transmission/distribution incidents, fireworks, railroad maintenance, firearms and explosive use.

Collected electrical power grid data can include EPG infrastructure details, grid vulnerability data and maintenance and operation records. The EPG infrastructure details can include information about the power grid layout, including the locations of power lines, transformers, substations, and other critical components. The grid vulnerability data can include information on previous incidents where wildfires impacted the grid, such as damaged components, power outages, and repair efforts. The maintenance and operation records can include data on grid maintenance schedules, upgrades, and past operational challenges can provide insights into potential vulnerabilities.

Before fusing the collected data, both wildfire and EPG data can be pre-processed that includes normalizing and standardizing them both to a common scale. Additionally, missing or uncertain values can be corrected to ensure data quality and consistency. A correlation analysis can be conducted to understand the relationships between the various features. This step helps in identifying any redundant or highly correlated features which might not add significant value to the model. Further, misalignments between datasets can be addressed as some datasets can provide daily data while others offer hourly or weekly data. As such, features in a given cell can be represented at the same temporal resolution using interpolation or aggregation techniques.

To fuse the collected data, the fusion method can include grid-based fusion and weighted fusion. To fuse the collected data with grid-based fusion, for a given grid cell (e.g., 1 km×1 km), aggregate the data from all datasets pertaining to that cell. This ensures that each cell contains a rich set of features representing all the variables.

To fuse the collected data with weighted fusion, weights can be assigned based on the significance of each feature for wildfire prediction to obtain assigned feature weights. For instance, during dry seasons, drought index can have higher predictive power than other features. Additionally, features in each grid cell using these assigned feature weights can be combined to ensure the most critical information is emphasized. The weights for different features are typically determined using a combination of methods such as expert judgment, based on the significance of each feature in wildfire dynamics. The experts can be a pre-trained model trained for wildfire dynamics, or human experts. Additionally, historical data analysis, such as Random Forests or Gradient Boosting Machines, can provide quantitative insights into the significance of each feature.

Thus, the fused data can include aggregated data from grid cells with assigned feature weights based on the significance of each feature for natural destructive force prediction that are aligned and correlated.

Referring now to block 120 of FIG. 1, showing an embodiment of a method of predicting vulnerability metric and fragility metric of the EPG based on risk profiles generated from the fused data with a physics-informed neural network (PINN) trained with the fused data.

The vulnerability metric can measure the vulnerability (e.g., susceptibility to threats) of the EPG. V_{gc} represents the vulnerability of grid component g to wildfire cause c, as predicted by the model: V_{gc}=f (P (C=c|X), I_{g}).

The fragility metric can measure the fragility (e.g., likelihood of failure when exposed) of the EPG. Fg(I, D) is the fragility of component g based on wildfire intensity I and proximity D.

The risk profiles can include causes of natural destructive force with behavioral attributes and the fragility and vulnerability metric for the causes of the natural destructive force. The risk profiles can include characteristics of the risk, such as wildfires, common locations of the risk, historical incidences, and impact on the power grid. To generate the risk profiles from fused data, a profile generator can be employed.

The characteristics of the risk can further include size, spread rate, duration, and intensity. The common locations of the risk can include areas or conditions where each type of natural destructive force is most likely to occur. The historical incidences can include an analysis of past occurrences to understand patterns and frequencies. The impact on the electrical power grid can include specific ways in which each type of natural destructive force can affect the electrical power grid, such as damage to transmission lines, risk to substations, or induced power outages.

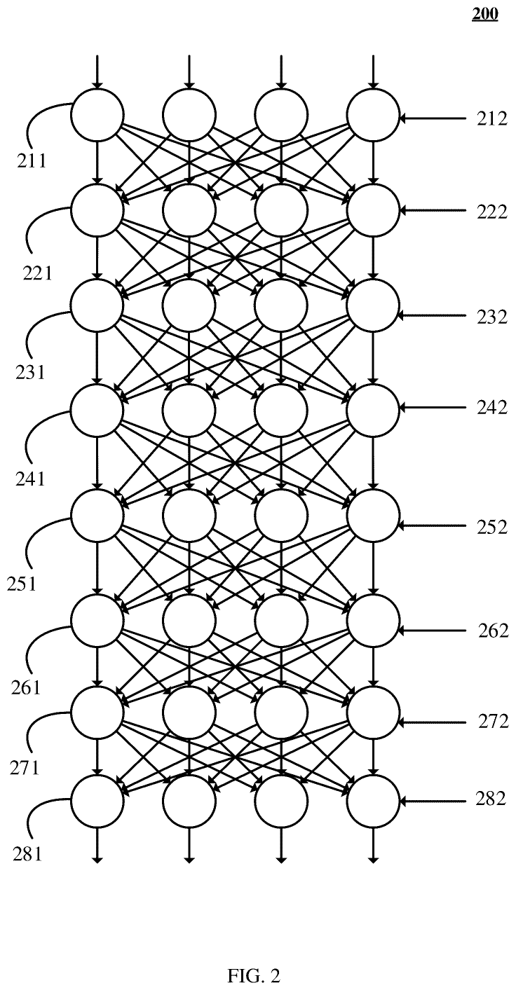

The system architecture of the PINN is described in more detail in FIG. 2.

Referring now to FIG. 2 showing a block diagram of a system architecture of the PINN, in accordance with an embodiment of the present invention.

The PINN 200 can include a deep learning neural network that can have an input layer 211, a convolutional layer 221, an activation layer 231, a recurrent layer 241, an attention mechanism layer 251, a physics-informed layer 261, a layer 271 and an output layer 281. The PINN 200 can also include skip connections to capture both immediate and long-term patterns in the data.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The input layer 211, with input layer node 212, can process the fused data. An input layer 211 can have a number of source neurons 212 equal to the number of data values 212 in the input data 211.

The computation neurons in the computation layer(s) that includes a convolutional layer 221, an activation layer 231, a recurrent layer 241, an attention mechanism layer 251, a physics-informed layer 261, and layer 271, which are fully-connected layers, can also be referred to as hidden layers, because they are between the source neurons 212 and output neuron(s) 282 and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ.

The convolutional layer 221, with convolutional layer node 222, detects spatial patterns between local patterns such as how wind impacts fire spread. The depth of the convolutional layers can be determined based on the complexity of the spatial patterns the present embodiments aim to capture. Initially, shallower layers might recognize simple patterns, like the immediate effect of wind direction. Deeper layers delve into more intricate patterns, like the combined effect of wind, drought index, and NDVI on fire spread.

The activation layer 231, with activation layer node 232, can capture the unique nonlinearities of natural destructive forces, such as wildfires. The activation layer 231 can employ a custom activation function, named FireAct, which is formulated specifically for wildfire dynamics. The FireAct function can be defined as: FireAct (x)=αx³+βx²+γx where α, β, γ are parameters learned during training, and x is the input to the activation function. The cubic function in FireAct is suited for wildfire dynamics because wildfires exhibit nonlinear behaviors, often with rapid accelerations in spread rate under certain conditions. The cubic term allows the model to capture rapid nonlinear increases, while the quadratic and linear terms account for more gradual changes. This complexity mimics the intricacies and sudden escalations seen in real-world natural destructive force dynamics.

In PINN 200, each neuron processes the input data (like wind speed, temperature, etc.), multiplies it by its weights, and passes it through an activation function. The activation function then decides the neuron's output. By introducing the custom FireAct activation function, the present embodiments can ensure that the PINN can capture intricate nonlinearities specific to natural destructive force dynamics.

The recurrent layer 241, with recurrent layer node 242, can grasp the temporal progression. The recurrent layer 241 can integrate long short-term memory (LSTM) or gated recurrent unit (GRU) layers.

The attention mechanism layer 251, with attention mechanism layer node 252, can detect and prioritize crucial regions or time periods such as zones with high-drought indices or periods of rapid wind speed changes.

The physics-informed layer 261, with physics-informed layer node 262, can ensure that predictions adhere to real-world natural destructive force dynamics. The real-world natural destructive force dynamics can be computed with reaction-diffusion equations. Reaction-diffusion equations describe how substances spread through space and interact over time. In the context of natural destructive forces, the “diffusion” part captures how a fire naturally spreads across a region, while the “reaction” part captures how external factors (like wind, humidity, etc.) influence the fire's behavior. Fire spread prediction F_{t+1,i,j} can be computed as:

$${F}_{t + 1 , i , j} = {F}_{t , i , j} + D {∇}^{2} {F}_{t , i , j} + R ( {F}_{t , i , j} , {W}_{t , i , j} , {T}_{t , i , j} , {H}_{t , i , j} , ... ) ,$$

where D is the diffusion coefficient, representing how fast the fire spreads on its own, V̅² the Laplacian operator, capturing the spatial spread of the fire, and R ( ) is the reaction term, accounting for external factors influencing the fire's behavior. The factors that can be used in the reaction term R ( ) can include: W_{t,i,j}: the wind vector in cell (i, j) at time t; T_{t,i,j}: Temperature in cell (i, j) at time t; H_{t,i,j}: Humidity in cell (i, j) at time t P_{t,i,j}: Precipitation in cell (i, j) at time t; E_{t,i,j}: Elevation of in cell (i, j); D_{t,i,j}: Drought index in cell (i, j) at time t; N_{t,i,j}: Normalized Difference Vegetation Index (NDVI) in cell (i, j) at time t; R_{t,i,j}: Energy Release Component (ERC) in cell (i, j) at time t; and rho_{t,i,j}: Population density in cell (i, j) at time t.

The layer 271, with layer node 272, can culminate the outputs of the layers before. The PINN 200 can be fully connected, where each neuron in a computational layer is connected to all other neurons in the previous layer, which can have other configurations of connections between layers. If links between neurons are missing, the network is referred to as partially connected.

The output layer 281, with output layer node 282, can provide the wildfire spread predictions that can include the vulnerability metric and the fragility metric. The output layer can provide the overall response of the network to the inputted data.

To train the PINN, a joint-loss function is minimized. The joint loss function can be computed as:

$$L = {\sum }_{i , j} {( {A}_{t + 1 , i , j} - {F}_{t + 1 , i , j} )}^{2} + {λ ( {F}_{t + 1 , i , j} - ( {F}_{t , i , j} + D {∇}^{2} {F}_{t , i , j} + R ( {F}_{t , i , j} , ... ) ) )}^{2}$$

where λ is a weighting factor that balances the importance of data-driven predictions A_{t+1,i,j} and physics-based constraints F_{t+1,i,j}. The balance between these two components is controlled by the hyperparameter λ. Since λ is utilized in determining the trade-off between data-driven and physics-informed learning, its optimal value needs to be determined. This can be achieved using techniques like cross-validation. By adjusting λ, the present embodiments can ensure that the model does not overly rely on just the data, but strikes a balance that results in accurate and realistic predictions.

Referring now to how the present embodiments can perform fine-tuning steps for the PINN 200. After training the PINN 200, a fine-tuning step can be performed. The fine-tuning step can include confidence thresholding, spatial smoothing, temporal calibration, and robust validation.

After the PINN makes a prediction, it doesn't just give a binary output (e.g., fire/no fire). Instead, the PINN can provide a confidence score for each prediction. By setting a confidence threshold, the present embodiments can filter out predictions that the model is uncertain about, thereby increasing the overall accuracy of the predictions the present embodiments act upon. The confidence score can include a probabilistic output from the neural network, representing the likelihood of fire presence. For instance, a softmax layer at the end of a classification neural network provides probabilities for each class (e.g., fire/no fire). This probability score can serve as the confidence score.

Wildfires, by nature, can spread in continuous patches. If the model predicts isolated cells of fire, it might be an anomaly or noise in the prediction. Using spatial smoothing techniques, such as Gaussian smoothing, the present embodiments can ensure that isolated prediction cells are refined to align better with the spatial continuity of real-world fire spread.

By analyzing predictions over a sequence of days, the present embodiments can identify and correct inconsistencies. For instance, if a region is predicted to have a fire on day 1 and day 3, but not on day 2, it can be an inconsistency that needs correction. Using temporal calibration, the present embodiments can ensure that the fire spread predictions are consistent over consecutive days. Techniques like moving averages or temporal interpolation can be used. For instance, if there's a prediction inconsistency between day 1 and day 3, the model can interpolate values for day 2, ensuring a smooth temporal progression.

Referring now on how the present embodiments can perform robust validation. Robust validation can include historical data comparison, simulation-based validation, regional validation, continuous learning and benchmarking.

Historical data comparison. The present embodiments can validate the model's predictions against a separate set of real-world natural destructive force events, such as wildfires, that the model hasn't seen during training. This ensures that the present embodiments test the model's generalization capability. By comparing predictions with actual fire spread in this historical data, the present embodiments can compute accuracy metrics.

Simulation-based validation. The present embodiments can use high-fidelity natural destructive force simulations to generate synthetic natural destructive force spread scenarios. The predictions from PINN can be validated against these simulations to assess how well it generalizes to simulated scenarios. Validating against simulated scenarios can help in situations where historical data might be limited or not diverse enough.

Regional Validation. Validate model predictions across various geographical regions. This ensures that the PINN performs well not just in one specific region but across diverse terrains and conditions.

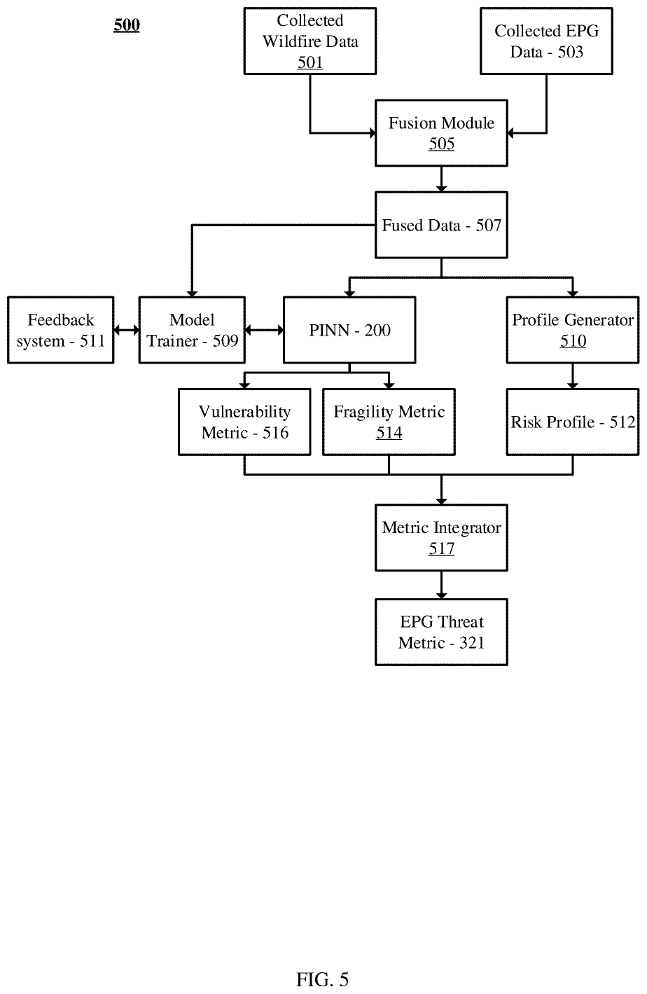

Continuous learning. Even after deploying the model, continuously monitor its predictions against real-world events. If deviations or inaccuracies are observed, the feedback is used to retrain or fine-tune the model, ensuring it remains updated. This is described in more detail in FIG. 5.

Referring back now to block 130 of FIG. 1, showing an embodiment of a method of developing EPG threat metrics by integrating the vulnerability metric, fragility metric, and the risk profiles.

The EPG threat metric can be a code package that includes an integrated score VFS_{gc} (I, D), for natural destructive force intensity I and proximity D, risk profiles for I, vulnerability metric for EPG for the risk profile, the fragility metric for the risk profile, a visualization object, and a guidance document. The EPG threat metric can be sent to different grid maintenance outposts through a network which enables real-time monitoring of the EPG.

The visualization object can visualize the EPG threat metric in a user-friendly manner, allowing decision-making entities to easily interpret and analyze the data. The visualization object can include a table of risk profiles, the integrated score, the fragility and vulnerability metrics. The visualization object can include a map of the EPG and its surroundings which visualizes the risk profiles, the fragility and vulnerability metrics of the EPG. For example, for a grid node that has a fragility metric of high can have a red color indicator and the risk profile that has a high-risk profile can have a red color indicator. The EPG threat metric can provide explanatory notes or guidance on how to use the EPG threat metric for planning and response purposes.

The integrated score, VFS_{gc} (I, D), can be computed as:
VFS_{gc} (I,D)=V_{gc}×F_{g} (I, D), where F_{g} (I,D) is the probability of failure of the EPG based on I and D;
To calculate a comprehensive risk profile for grid component g, the integrated score VFS_{gc} (I, D) can be summed for all considered causes c in the set C: VFS_{g}=E_{c ∈C} VFS_{gc} (I, D).

The EPG threat metric can be dynamically updated in real-time based on newly collected risk data and EPG data. This ensures that changes in weather conditions, vegetation dryness, and other relevant factors are reflected in the recalibration process. To dynamically update the EPG threat metric with new data, given Vgv (t) πr² and F_{g} (t) (I,D) represent the vulnerability and fragility assessments at time t, r is the radius of the area from which the new data has been collected. With new data Dt+1, these are updated to Vgv(t+1) and F_{g} (t+1) (I, D):

$${V}_{gv}^{( t + 1 )} = Update ( {V}_{gv}^{( t )} , {D}_{t + 1} ) ;$$

$${F}_{g}^{( t + 1 )} = Update ( {F}_{g}^{( t )} ( I , D ) , {D}_{t + 1} ) .$$

Referring now to block 140 of FIG. 1, showing an embodiment of a method of mitigating risks to the electrical power grids determined from the threat metrics through developed mitigation strategies.

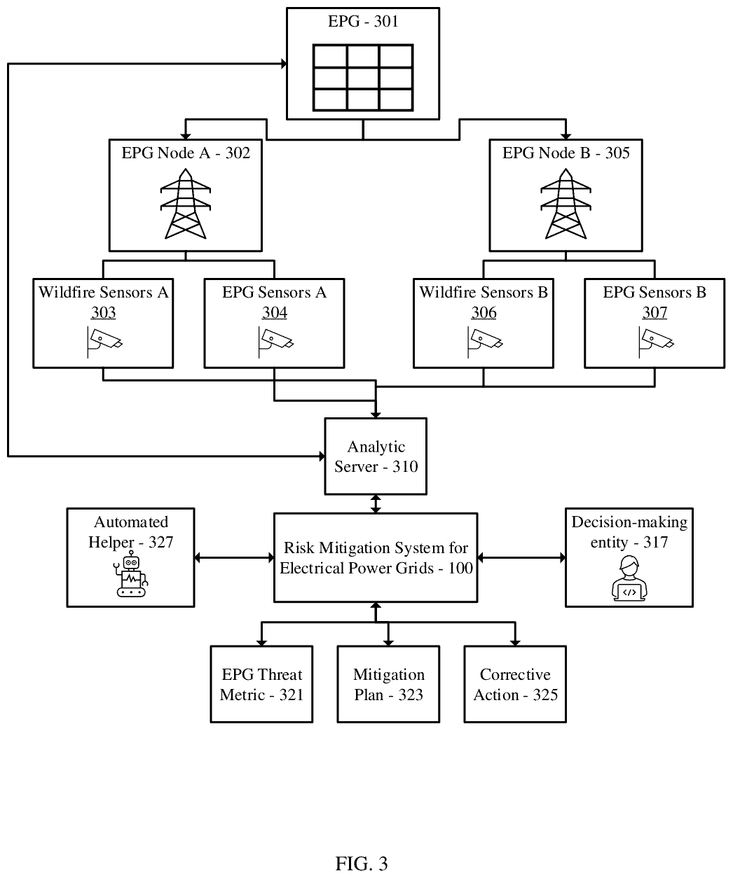

This is described in more detail in FIG. 3.

Referring now to FIG. 3 showing a block diagram of a system implementing a practical application of a risk mitigation system for electrical power grids, in accordance with an embodiment of the present invention.

The system 300 can mitigate risks for EPG 301 that can include numerous EPG nodes such as EPG Node A 302 and EPG Node B 305.

EPG Node A 302 can include natural destructive force sensors such as wildfire A 303 and EPG sensors A 304 that can collect natural destructive force data and EPG data for EPG Node A 302, respectively. EPG Node B 305 can include natural destructive force sensors such as wildfire B 306 and EPG sensors B 307 that can collect natural destructive force data and EPG data for EPG Node B 305, respectively. Both EPG Node A 302 and EPG Node B 305 can send their respective natural destructive force data and EPG data to the analytic server 310 through a network which can implement the risk mitigation system for electrical power grids 100. The analytic server can generate the EPG threat metric 321, the mitigation plan 323 and corrective action 325 for the EPG 301. The network can implement a cloud computing environment, other network implementations can be employed. The EPG threat metric 321 can include specific EPG threat metrics 321 for each EPG node include EPG Node A 302 and EPG node B 305.

The mitigation plan 323 can include mitigation strategies such as preventative planning and rapid response protocols. Preventative planning can include developing plans to prevent or minimize the impact of natural destructive forces on the grid, such as enhanced surveillance, predictive maintenance, or grid redesign. Rapid response protocols can include protocols for quick and effective response to natural destructive force incidents, ensuring minimal disruption and rapid recovery of grid operations. For example, a rapid response protocol can include notifying EPG grid maintenance outputs of an incoming thunderstorm and to alert the local fire brigade about the risk of the incoming thunderstorm turning into a natural destructive force. The mitigation plan 323 can be presented to a decision-making entity 317 to assist its decision-making process regarding the EPG 301. In another embodiment, the decision-making process can generate the corrective action 325 through the decision-making entity 317.

The corrective action 325 can include targeted protective measures, resource allocation and mobilization, and communication. The corrective action 325 can also include redirecting power generated from one node determined to be affected by a natural destructive force to another node, shutting down a node, etc. The corrective action 325 can be performed by automated helper 327 programmed to perform the corrective action 325. The automated helper 327 can be a robot, drone, or artificial intelligence (AI) assistant.

Targeted protective measures, based on the risk profiles, can include infrastructure hardening, vegetation management, or technological upgrades. For example, infrastructure hardening for EPG Node A 302 can include repairing the distribution lines, transmission towers, etc. Vegetation management can include trimming down branches of trees that touch or imminently touch the EPG 301. Technological upgrades can include updating transformers, distribution lines, software for the analytic server 310, etc.

Resource allocation and mobilization can include strategic allocation and mobilization of resources, including personnel, equipment, and communication tools, in the event of a natural destructive force.

Communication can include notifying key stakeholders such as engaging with local authorities, emergency services, and community leaders to ensure coordinated efforts and community preparedness. In an embodiment, each key stakeholder can access a cloud distributed application that shows the status of the EPG 301, including the EPG threat metric 321, the mitigation plan 323 and the status of the corrective actions 325.

The present embodiments can provide a more comprehensive, accurate, and actionable assessment of the risks natural destructive forces pose to the power grid. Thus, the present embodiments can ensure not only enhanced grid resilience but also more informed, targeted, and effective mitigation strategies.

The present embodiments are not limited to natural destructive forces and can be utilized for other failure risks to EPGs such as flooding, landslides, hurricanes, software infrastructure attacks, grid infrastructure attacks, etc.

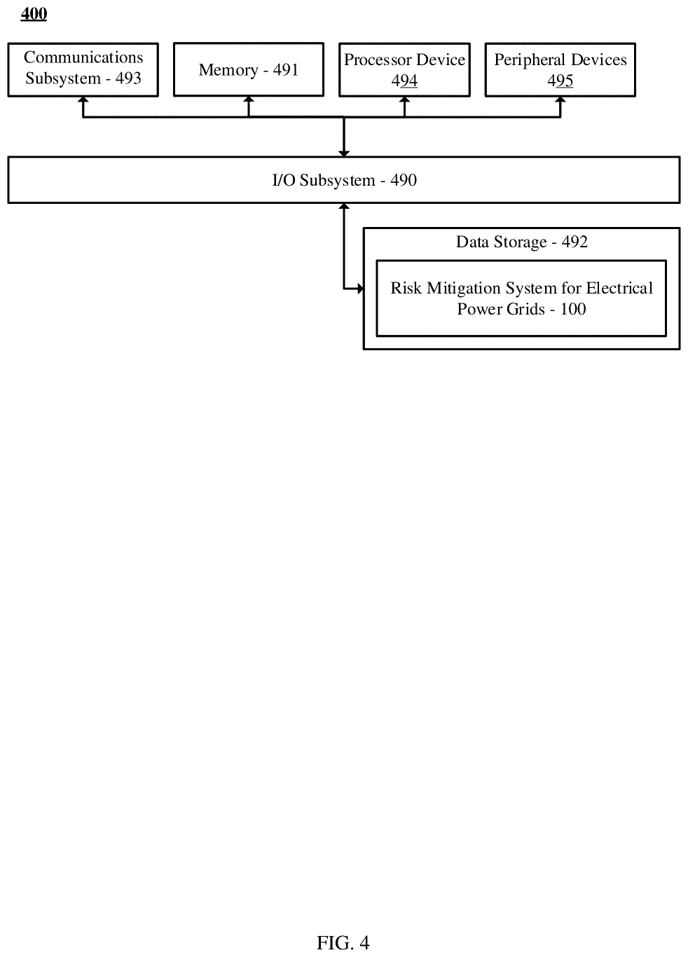

Referring now to FIG. 4, a computing device for risk mitigation system for electrical power grids is illustratively depicted in accordance with an embodiment of the present invention.

The computing device 400 illustratively includes the processor device 494, an input/output (I/O) subsystem 490, a memory 491, a data storage device 492, and a communication subsystem 493, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the computing device 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the computing device 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the computing device 400, on a single integrated circuit chip.

The data storage device 492 may be embodied as any type of device or devices configured for short-term or long-term storage of data such as, for example, memory devices and circuits, memory cards, hard disk drives, solid state drives, or other data storage devices. The data storage device 492 can store program code for risk mitigation system for electrical power grids 100. Any or all of these program code blocks may be included in a given computing system.

The communication subsystem 493 of the computing device 400 may be embodied as any network interface controller or other communication circuit, device, or collection thereof, capable of enabling communications between the computing device 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 400 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 5, a block diagram showing a system that implements software and hardware components of a risk mitigation system for electrical power grids, in accordance with an embodiment of the present invention.

System 500 can include a fusion module 505, the PINN 200, a model trainer 509 a profile generator 510, and a metric integrator 517. The fusion module 505 can fuse collected risk data 501 and the collected EPG data 503 to generate fused data 507.

The fused data 507 can be used by the PINN 200 to generate the vulnerability metric 516 and the fragility metric 514. The fused data can be used by the profile generator 510 to generate risk profile 512. The fused data can be used by the model trainer 509 to train the PINN 200.

In an embodiment, the model trainer 509 can continuously train the PINN 200 using feedback obtain from a feedback system 511. The PINN 200 can retain previously learned knowledge through regularization techniques such as elastic weight consolidation (EWC). The feedback system 511 can obtain feedback from experts that can verify the accuracy of the predictions of PINN 200. The experts can be a pre-trained model specifically trained to predict risks. In another embodiment, the experts can be decision-making entities (e.g., human). The feedback system 511 can include a feedback peripheral such as touch, text, audio, video, etc.

The model trainer 509 can also perform robust validation as described herein.

The vulnerability metric 516, fragility metric 514 and risk profile 512 can be utilized by the metric integrator 517 to generate the EPG threat metric 321. The EPG threat metric 321 can then be used to generate the corrective actions 325 and mitigation plans 323 to prevent issues with the EPG 301.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for mitigating risks for electrical power grids, comprising:
fusing collected risk data and electrical power grid (EPG) data to obtain fused data;
predicting a vulnerability metric and a fragility metric of the EPG based on risk profiles generated from the fused data with a physics-informed neural network (PINN) trained with the fused data;
developing EPG threat metrics by integrating the vulnerability metric, fragility metric, and the risk profiles into an integrated score that determines the probability of failure of the EPG caused by natural destructive forces; and
performing, with an automated helper, a corrective action to mitigate the risks to the EPG caused by the natural destructive forces determined from the EPG threat metrics.

2. The computer-implemented method of claim 1, wherein fusing the collected risk data and the EPG data, further comprises assigning weights based on a significance of each feature for natural destructive force predictions to obtain assigned feature weights.

3. The computer-implemented method of claim 2, wherein fusing the collected risk data and the EPG data, further comprises combining features in grid cells using the assigned feature weights.

4. The computer-implemented method of claim 1, wherein the predicting vulnerability metric and the fragility metric further comprises training the PINN by minimizing a joint-loss function that balances data-driven predictions and physics-based constraints that is controlled by a hyperparameter.

5. The computer-implemented method of claim 1, wherein the predicting vulnerability metric and the fragility metric further comprises filtering out predictions based on a confidence threshold computed using a softmax layer.

6. The computer-implemented method of claim 1, wherein the predicting vulnerability metric and the fragility metric further comprises continuously learning the vulnerability metric and the fragility metric using feedback obtained from a feedback system and newly collected data while retaining previously learned knowledge.

7. The computer-implemented method of claim 1, wherein developing the EPG threat metrics further comprises generating a visualization object that presents the EPG threat metric in a map that includes the risk profiles, the fragility and vulnerability metrics of the EPG.

8. The computer-implemented method of claim 1, wherein performing the corrective action further comprises redirecting power generated from one node determined to be affected by the natural destructive forces to another node.

9. A risk mitigation system for electrical power grids, comprising:
a memory device;
one or more processor devices operatively coupled with the memory device to:
fuse collected risk data and electrical power grid (EPG) data to obtain fused data;
predict a vulnerability metric and a fragility metric of the EPG based on risk profiles generated from the fused data with a physics-informed neural network (PINN) trained with the fused data;
develop EPG threat metrics by integrating the vulnerability metric, fragility metric, and the risk profiles into an integrated score that determines the probability of failure of the EPG caused by natural destructive forces; and
perform, with an automated helper, a corrective action to mitigate the risks to the EPG caused by the natural destructive forces determined from the EPG threat metrics.

10. The risk mitigation system of claim 9, further comprising a network of sensors to collect natural destructive force data and EPG data from the EPG and its surroundings.

11. The risk mitigation system of claim 9, wherein the PINN further comprises a physics-informed layer that ensures predictions adhere to real-world natural destructive force dynamics.

12. The risk mitigation system of claim 9, wherein the PINN further comprises an activation layer that employs a custom activation function formulated for natural destructive force dynamics using a cubic function that employs parameters learned during training and input data.

13. A non-transitory computer program product comprising a computer-readable storage medium including program code for mitigating risks for electrical power grids, wherein the program code when executed on a computer causes the computer to:
fuse collected risk data and electrical power grid (EPG) data to obtain fused data;
predict a vulnerability metric and a fragility metric of the EPG based on risk profiles generated from the fused data with a physics-informed neural network (PINN) trained with the fused data;
develop EPG threat metrics by integrating the vulnerability metric, fragility metric, and the risk profiles into an integrated score that determines the probability of failure of the EPG caused by natural destructive forces; and
perform, with an automated helper, a corrective action to mitigate the risks to the EPG caused by the natural destructive forces determined from the EPG threat metrics.

14. The non-transitory computer program product of claim 13, wherein to fuse the collected risk data and the EPG data, further comprises assigning weights based on a significance of each feature for natural destructive force predictions to obtain assigned feature weights.

15. The non-transitory computer program product of claim 14, wherein to fuse the collected risk data and the EPG data, further comprises combining features in grid cells using the assigned feature weights.

16. The non-transitory computer program product of claim 13, wherein to predict vulnerability metric and the fragility metric further comprises training the PINN by minimizing a joint-loss function that balances data-driven predictions and physics-based constraints that is controlled by a hyperparameter.

17. The non-transitory computer program product of claim 13, wherein to predict vulnerability metric and the fragility metric further comprises filtering out predictions based on a confidence threshold computed using a softmax layer.

18. The non-transitory computer program product of claim 13, wherein to predict vulnerability metric and the fragility metric further comprises continuously learning the vulnerability metric and the fragility metric using feedback obtained from a feedback system and newly collected data while retaining previously learned knowledge.

19. The non-transitory computer program product of claim 13, wherein to develop the EPG threat metrics further comprises generating a visualization object that presents the EPG threat metric in a map that includes the risk profiles, the fragility and vulnerability metrics of the EPG.

20. The non-transitory computer program product of claim 13, wherein to perform the corrective action further comprises redirecting power from a node determined to be affected by the natural destructive forces to another node.
